(19) United States
(12) Patent Application Publication
(10) Pub. No.: US 2013/0138708 A1
(43) Pub. Date: May 30, 2013

(54) DOCUMENT PROCESSING APPARATUS

(71) Applicants: Yusuke Hamada, Shizuoka (JP); Kazuhiro Ogura, Kanagawa (JP); Shinji Makishima, Shizuoka (JP); Akihiro Mizutani, Shizuoka (JP); Toshihiro Ida, Shizuoka (JP)

(72) Inventors: Yusuke Hamada, Shizuoka (JP); Kazuhiro Ogura, Kanagawa (JP); Shinji Makishima, Shizuoka (JP); Akihiro Mizutani, Shizuoka (JP); Toshihiro Ida, Shizuoka (JP)

(73) Assignees: TOSHIBA TEC KABUSHIKI KAISHA, Tokyo (JP); KABUSHIKI KAISHA TOSHIBA, Tokyo (JP)

(21) Appl. No.: 13/685,857

(22) Filed: Nov. 27, 2012

Related U.S. Application Data
(60) Provisional application No. 61/564,383, filed on Nov. 29, 2011.

(51) Int. Cl. G06F 17/30

(52) U.S. Cl. CPC G06F 17/30194
USPC 707/827

(57) ABSTRACT

According to an embodiment, there is provided a document processing apparatus including an electronic file storage unit that stores a plurality of electronic files; an upload time estimation unit that estimates time that will be taken to upload a specified electronic file to a destination if one or more electronic files stored in the electronic file storage unit are selected in a specific destination via a network for performing the upload; and a notification unit that notifies that an allowable time will be exceeded if the time estimated by the upload time estimation unit exceeds a predetermined allowable time.

### CROSS-REFERENCE TO RELATED APPLICATION

This application is based upon and claims the benefit of priority from Provisional U.S. Application 61/564,383 filed on Nov. 29, 2011. The entire contents of which are incorporated herein by reference.

### FIELD

Embodiments described herein relate generally to a document processing apparatus and an upload processing method of an electronic file for uploading and transmitting a scanned document or a file via a network to a server.

### BACKGROUND

In the related art, when a document or a file is uploaded and its capacity is high, there has been a case where a long time is taken until the upload is finished and the upload fails in the middle of the upload.

An example of the present disclosure is to provide a document processing apparatus and an upload processing method of an electronic file capable of uploading within a time period requested by a user.

### BRIEF DESCRIPTION OF THE DRAWINGS

FIG. 1 illustrates a view of a configuration of the entire system of a first embodiment.

FIG. 2 illustrates a view of a configuration example of a document processing apparatus of FIG. 1.

FIG. 3 illustrates a flowchart for illustrating an operation of an upload routine.

FIG. 4 illustrates a flowchart for illustrating an operation of a case when an upload is to be performed using a tab browser in an embodiment.

FIG. 5 illustrates a view illustrating a relationship between a tab ID and a URL when a plurality of tabs are produced.

FIG. 6 illustrates a view illustrating a display screen that specifies a file to be uploaded in an embodiment.

FIG. 7 illustrates a view illustrating an example of a display screen setting a format scanning when a file to be uploaded is a paper document in an embodiment.

FIG. 8 illustrates a view illustrating an example of a display screen inputting an allowable time to an upload in an embodiment.

FIG. 9 illustrates a view illustrating an example of a display screen selecting a file to be uploaded in an embodiment.

FIG. 10 illustrates a view illustrating an example of a display screen when an upload estimation time exceeds the allowable time in an embodiment.

FIG. 11 illustrates a view illustrating an example of a set display screen when a rescan is performed if the upload estimation time exceeds the allowable time in an embodiment.

### DETAILED DESCRIPTION

According to the disclosure, there is provided a document processing apparatus including:

an electronic file storage unit that stores a plurality of electronic files; an upload time estimation unit that if one or more electronic files stored in the electronic file storage unit are selected to be uploaded to a specific destination via a network, estimates time that will be taken to upload the selected electronic file to the destination and a notification unit that notifies that an allowable time is exceeded if the time estimated by the upload time estimation unit exceeds a predetermined allowable time.

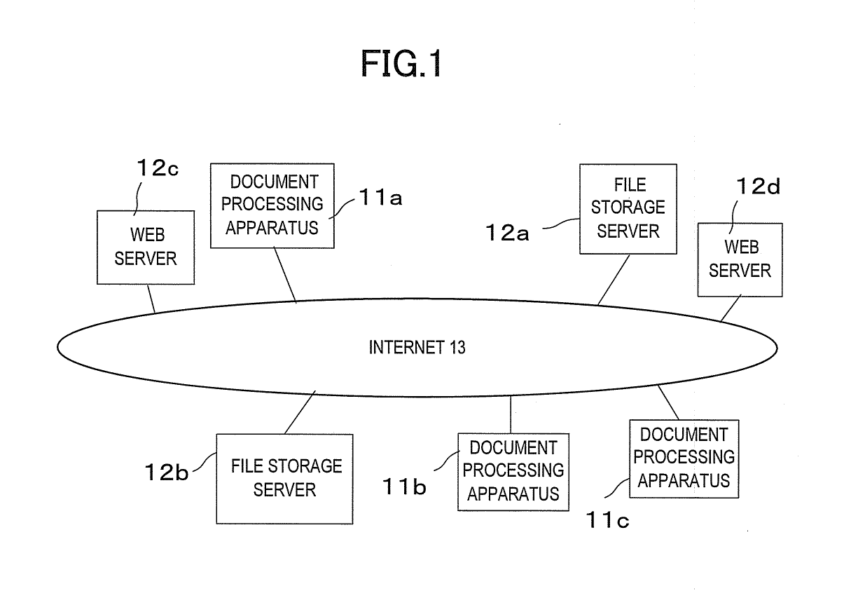

An embodiment will be described. A configuration of the entire system in an embodiment is illustrated in FIG. 1.

The entire system includes document processing apparatuses 11a, 11b, 11c that perform file processes of an upload or a download of electronic files, file storage servers 12a and 12b that store the electronic files uploaded from those document processing apparatuses 11a, 11b and 11c in a downloadable state, normal Web servers 12c and 12d and a network, for example, an internet 13 connected to the units.

Herein, while there are three document processing apparatuses and two file storage servers; there may be a larger or smaller numbers of these apparatuses.

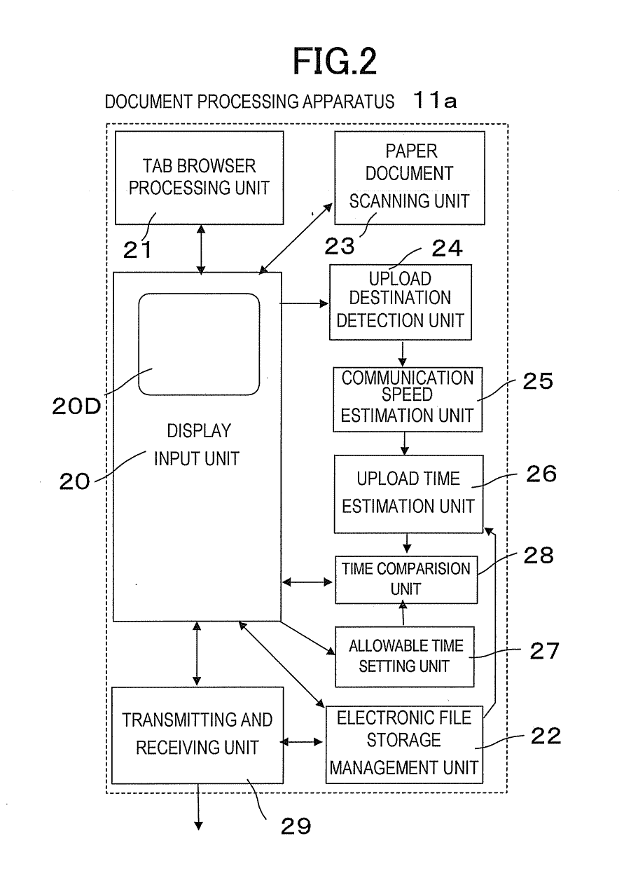

The document processing apparatuses 11a, 11b and 11c have the same configuration and for example, a configuration example of the document processing apparatus 11a is illustrated in FIG. 2.

The document processing apparatus 11a includes a display input unit 20 that can display a Web screen of the internet and that moves an icon by a mouse on the display screen and clicks the mouse to perform a specific process, a tab browser processing unit 21 that performs a tab display on the screen of the display input unit 20 to perform a browser process, an electronic file storage management unit 22 that stores the electronic files to be uploaded, a paper document scanning unit 23 that scans a paper document if a document to be uploaded is the paper document, an upload destination detection unit 24 that detects an upload destination if the upload destination is specified on the display screen of the display input unit 20, a communication speed estimation unit 25 that investigates a route up to the upload destination specified from the document processing apparatus 11a and that estimates the communication speed considering the current time and the like, an upload time estimation unit that estimates upload time from the estimated communication speed, a distance of the route and a capacity of the electronic file selected in the electronic file storage management unit 22, an allowable time setting unit 27 in which an allowable upload time is input, a time comparison unit 28 that compares the allowable time set in the allowable time setting unit 27 with the upload estimation time estimated in the upload time estimation unit 26, and a transmitting and receiving unit 29 that uploads the electronic file stored and selected in advance in the electronic file storage management unit 22 or downloads the electronic files from the outside.

The document processing apparatus 11a illustrated in FIG. 2 mainly illustrates a configuration necessary to upload the file. However, in fact, in addition, the document processing apparatus has a function that processes the document, but is not limited to thereto. Generally, it is nature that the document processing apparatus is called a multi-functional peripheral (MFP).

The tab browser processing unit 21 is one of the Web browser including processes and transmits a request command which requires an operation screen with respect to the Web server having a specific URL. In contrast to this, a Web application on the Web server transmits, to the document processing apparatus 11a, HTML data as a response, which performs the processes for producing HTML data for displaying the Web browser on the screen.

The Web browser of the document processing apparatus 11a which receives the HTML data displays the screen as described in disclosure of the received HTML data.

For example, when seeing a Web page of the Web server 12d from the document processing apparatus 11a, the URL of the Web server 12d is input or a word or a phrase detected and having an underline display is clicked. Therefore, the contents of the Web page of the Web server 12d are displayed.

In addition, when viewing the different Web page, the corresponding page of the Web server 12d present in the URL is displayed by clicking interesting portions displayed by the search results.

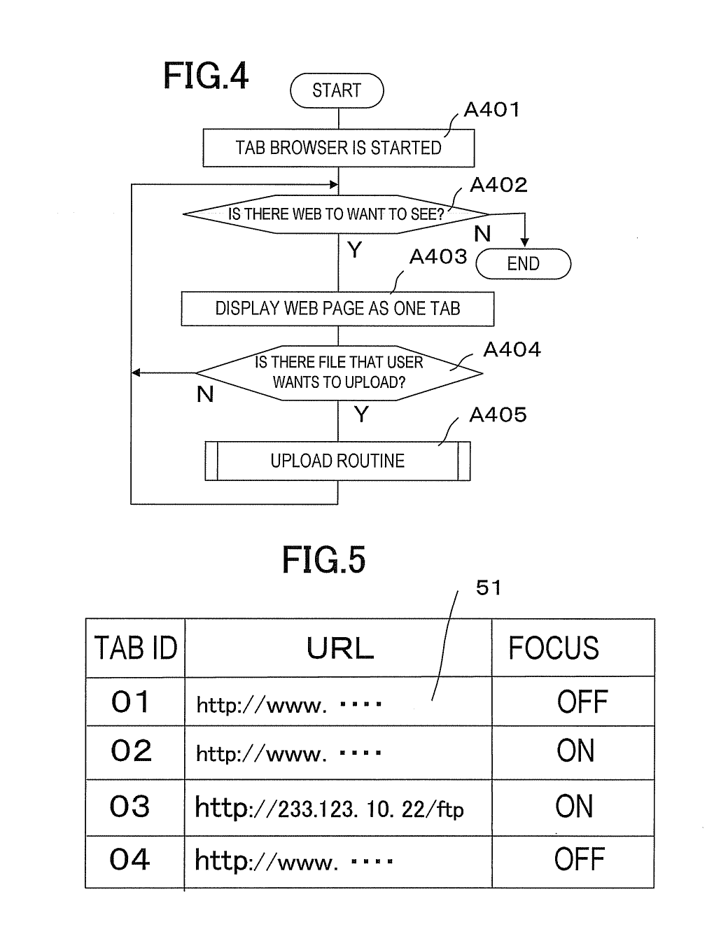

FIG. 4 illustrates a flowchart when the Web page to be seen in a tab browser is displayed and in particular, a specific file is uploaded. First, in act A401, the tab browser is started. In act A402, it is checked whether there is a Web page to be seen and if there is the Web page to be seen, go to the Web page and open the page in act A403. For example, the corresponding page is opened if the user page is moved from the document processing apparatus 11a to the Web server 12d. In each tab, for example, a tab ID of two digits is dumped in order. The tab ID and the URL of a destination correspond to each other as illustrated in 51 in FIG. 5. In this case, the Web page that is now open corresponds to tab ID01.

A focus illustrated in FIG. 5 illustrates whether the screen of the tab is active and if the screen of the tab is active, the focus is turned on. In general, only one of a plurality of screens appears on the front thereof and then is active. However, the focus is turned on exceptionally with respect to the tab uploaded even if the other tabs are turned on. Then, the “on” is continuous until the upload of the matter is finished.

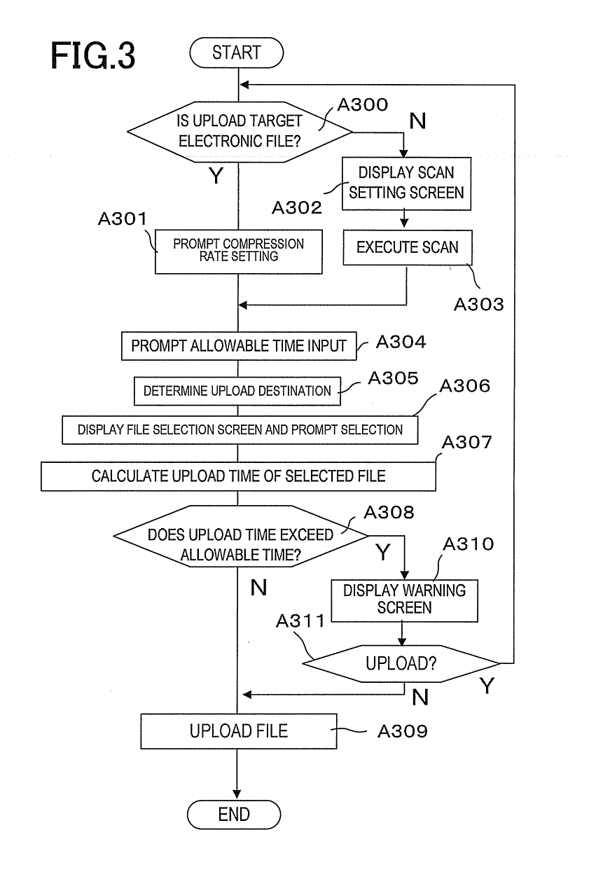

In act A404 in FIG. 4, it is checked whether there is a file that the user wants to upload and if such a file is present, the act is moved to the act A405 to start an upload routine. The routine will be described in detail below with reference FIG. 3.

Therefore, the Web page to want to be seen and the upload are made compatible with the tab browser.

FIG. 5 illustrates an example in which four tabs are produced and the relationship of the tab ID, each URL, and the focus when the upload is performed with respect to a tab ID03 among the four tabs is shown.

The Web page is displayed with respect to tabs ID01, 02 and 04 and 03 performs upload. If the upload is finished, the tab disappears. The display in which the upload is finished at the frontmost surface on the display screen before a disappearance of the tab may be performed.

The electronic file storage management unit 22 stores various types of electronic files and the stored electronic files are made to display on a display screen 20D of the display input unit 20 possible. The electronic file to be uploaded is stored in the electronic file storage management unit 22, the name is made to display on the display screen 20D of the display input unit 20 and is specified by a selection of the user and then the electronic file is uploaded from the transmitting and receiving unit 29.

The electronic files transmitted from the other document processing apparatus or the electronic file downloaded from the Web server are received via the transmitting and receiving unit 29 and are stored and managed in the electronic file storage management unit 22.

If the file to be uploaded is a paper document, an electronic scanning is performed in the paper document scanning unit 23 and then the scanned file is stored in the electronic file storage management unit 22 to which the name is given.

In addition, in the display screen 20D of the display input unit 20, it is possible to display instruction menus of the processes or a current state of the processes selected by user or a sentence that draws the attention of the user in addition to the contents of individual electronic files and the like.

Next, an operation when the upload is performed in the document processing apparatus of the embodiment using the upload routine in FIG. 4 is described by a flowchart described in FIG. 3.

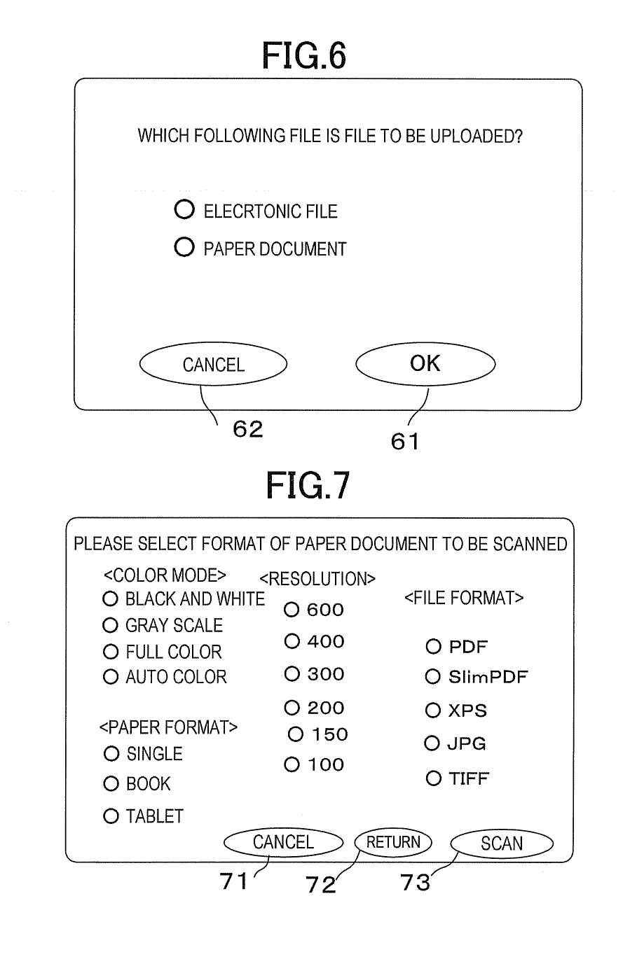

First, in act A300, the electronic file storage management unit 22 prompts the user to select the electronic file or the paper file as the file to be uploaded. FIG. 6 illustrates an example of an upload file selection screen. The selection screen is displayed in the display screen 20D of the display input unit 20. For example; “which the following file is the file to be uploaded?” is displayed on the upper stage and “electronic file” and “paper document” are displayed below that. A “OK” icon 61 and a cancel icon 62 are displayed in the lower stage. The menu screen is canceled if a cursor is moved to the cancel icon 62 by a mouse (not shown) and the icon is clicked.

On the other hand, a format of the file to be uploaded is detected if either “electronic file” or “paper document” is selected and the “OK” icon 61 is clicked.

If the upload target is the electronic file (Y at A300), the user is prompted to set the compression rate of the electronic file to be uploaded in act A301.

Meanwhile, if the user is recognized to select “paper document” (N at A300) in act A300, the act proceeds to act A 302 and a scan setting screen is displayed on the display screen 20D of the display input unit 20. An example of a scan format setting screen is illustrated in FIG. 7.

In the setting screen illustrated in FIG. 7, “Please select a format of a paper document to be scanned” is displayed in the top stage and a color mode, a paper format, a resolution and a file folder are each set below that. For the color mode one of black and white, gray-scale, full-color and auto-color may be selected and for the paper format, one of single, a book and a tablet may be selected. In addition, one of 600 (dpi), 400, 300, 200, 150, and 100 can be selected as the resolution and one of PDF, Slim PDF, XPS, JPG and TIFF can be selected as the file format.

In addition, the setting values of the highest frequency such as the black and white, single, 300, and PDF are set as a default and the default may be changed by the user. In addition, the color mode may automatically recognize the black and white and the color using a pre-scanning.

A cancel icon 71, a return icon 72 and a scan icon 73 are displayed in the lower stage. If the canceling icon 71 is clicked, the selection screen is canceled. If the return icon 72 is clicked, the screen in FIG. 6 that is a previous screen is displayed. In addition, if the scanning icon 73 is clicked, the scanning for the paper document to be a target in the condition set in the upper stage is performed (act A303). The scanned paper document is converted into an electronic file and is stored in the electronic file storage management unit 22.

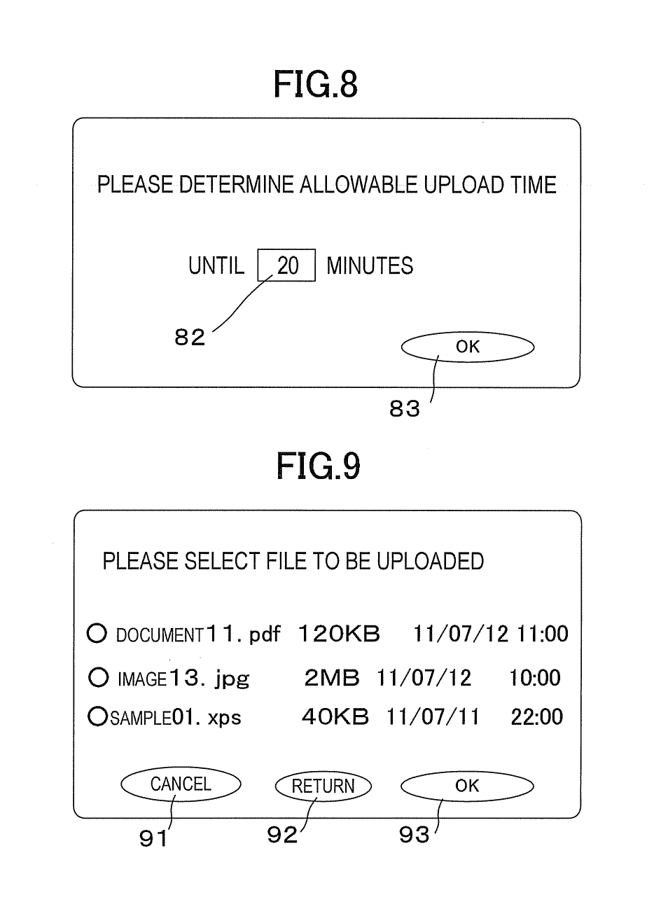

In act A304, a time is input that is allowed during the upload. FIG. 8 illustrates a screen example of the input. “Please determine an allowable upload time” is displayed in the upper stage, below which “by * minute” is displayed and a column 82 at the left thereof is displayed in which the allowable upload time is input, for example, in minute. The time for which the upload is allowable is input in the column 82 and if a “OK” icon 83 displayed in the lower and right thereof is clicked, the input time is stored in an allowable time setting unit 27.

The allowable time may be input in advance as the default value (time) and a user can change this time.

In act A305, the upload destination is displayed on the display screen 20D of the display input unit 20 and the upload destination is determined. This upload destination is detected in the upload destination detection unit 24 and thus a route from the document processing apparatus 11a to the upload destination is examined and assumed in the communication speed estimation unit 25. Therefore, a communication speed at which the data passes through the route is estimated. In this case, that the current time at which the upload is achieved is considered. The communication speed is not limited to this, and may be changed by the interval of the route and preferably, the communication speed is estimated by taking the route into consideration as much as possible.

In act A306, the electronic files stored in the electronic file storage management unit 22 are displayed on the display screen 20D. An example of the display screen is illustrated in FIG. 9.

In the display screen, “Please select a file to be up loaded” is displayed on the upper stage, below which the stored electronic files are displayed. As described above, the electronic files obtained by scanning the paper document are also stored in the electronic file storage management unit 22 in advance and are displayed in the display screen 20D. In this example, a document11.pdf, an image13.jpg, a sample01.xps, a capacity of each file and the most recent update time are displayed. If all documents are not displayed on one screen, the documents are sequentially displayed on two or more screens. One of the displayed documents is selected.

A cancel icon 91, a return icon 92 and a “OK” icon 93 are displayed on the lower stage and if the cancel icon 91 is clicked, the upload selection screen is canceled. If the return icon 92 is clicked, the screen is returned to the previous screen. Meanwhile, if any document is selected by clicking and the “OK” icon is clicked, the document to be uploaded is specified. A capacity of the specified electronic file is transmitted to the upload time estimation unit 26.

In act A307, the upload time for the selected electronic file is calculated. The calculation is made in the upload time estimation unit 26.

In act A308, the time comparison unit 28 compares the estimated upload time calculated in the upload time estimation unit 26 with the allowable time input in act A304 in advance and checks whether the allowable time is exceeded or not.

If the upload time does not exceed the allowable time (N in A308), act A308 proceeds to act A 309 and uploads the corresponding electronic file stored in the electronic file storage management unit 22 to the destination where the upload occurs from the transmitting and receiving unit 29.

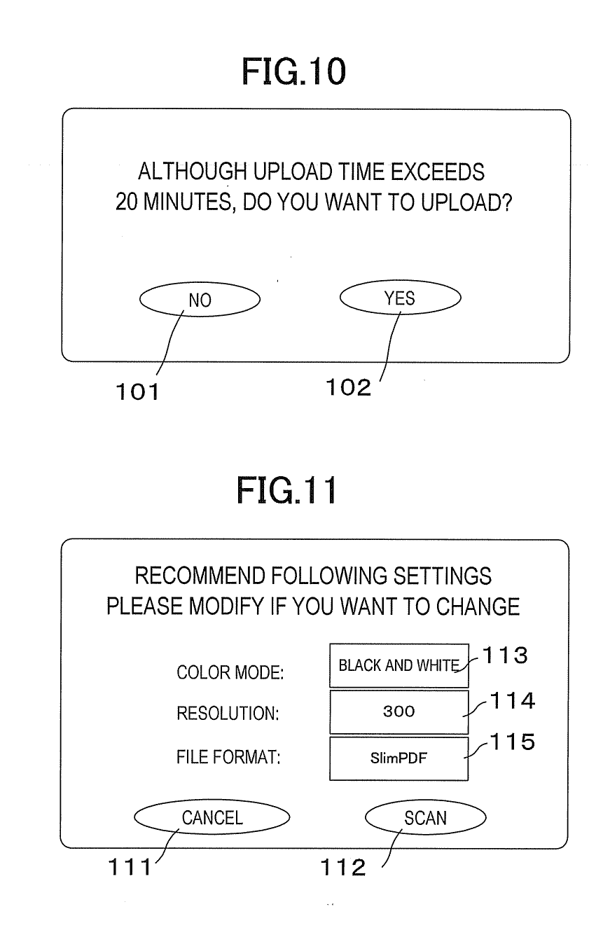

Meanwhile, if the upload time exceeds the allowable time (Y at A308), the act proceeds to act A 310, and for example, the excess upload time described in FIG. 10 is displayed in the display screen 20D to call the attention of the user. A notification unit indicating that the upload estimation time exceeds the allowable time is included in the display input unit 20.

In the example in FIG. 10, “Though upload time exceeds 20 minutes, “do you want to upload?” is displayed in the upper stage on the display screen, below which a No icon 101 and an YES icon 102 are displayed. The example in FIG. 10 means the act A310 and act A311.

If the YES icon 102 is pressed, the act proceeds to act A309 and the electronic file stored in the electronic file storage management unit 22 is uploaded in an original state.

Meanwhile, if the No icon 101 is pressed, since the upload does not occur, the act returns to act A300 from act A311 and thus whether a target for the upload is the electronic file is determined. If the target for the upload is the electronic file, in act A301, the compression ratio is increased and the capacity of the file is decreased. In addition, if the target for the upload is the paper document, the act is followed by returning to act A 302 to display the scan setting screen. In this case, FIG. 11 illustrates an example of the scan setting screen displayed in the display screen 20D.

“Recommend the following setting. Please correct if modified” is displayed in the upper stage of the display screen in FIG. 11.

Below that, for example, a color mode, a resolution and a file format are each displayed as black and white, 300, and Slim PDF. These setting values are recommended values for decreasing the capacity of the file.

In the lower stage, a cancel icon 111 and a scan icon 112 are displayed. If the scan icon 112 is clicked, the setting value is rescanned. The setting values of the color mode, the resolution and the file format can be modified in columns 113, 114 and 115 to input thereto. These setting at the time of scanning and the scan are performed on the paper document scanning unit. In act A302, the condition of the scan is set, an actual rescan is performed in act A 303 and then the scanned data are input again to the electronic file storage management unit 22.

It is possible to decrease the capacity by increasing the compression ratio in act A301 using the electronic file of the scan which has been made in advance without re-scanning. Therefore, it is possible to decrease the capacity of the electronic file without re-scanning the paper document, so that decreasing the upload time.

After the electronic file is decreased, the processes of act A304 to act A309 are performed similar to the previous cases. In addition, if the time of upload is long, if the time is made short, it is possible to return to act A300 again to be amended.

As described above, according to the embodiment, it is possible to provide the document processing apparatus capable of performing the upload within the allowable time set by the user. It is possible to provide the document processing apparatus and the method of processing the upload of the electronic file that display an excess upload time if it is difficult to perform the upload within the allowable time and that decrease the capacity of the electronic file to be uploaded.

In addition, in the embodiment, it is assumed that there is one electronic file to be uploaded. However, a plurality of electronic files may be uploaded at the same time.

Further, in the embodiment described above, if the estimated upload time exceeds the allowable time, the fact can be displayed on the display screen. However, the fact may be notified by another method such as sound and may call the attention of the user.

While certain embodiments have been described these embodiments have been presented by way of example only, and are not intended to limit the scope of the inventions. Indeed, the novel apparatus and methods described herein may be embodied in a variety of other forms: furthermore various omissions, substitutions and changes in the form of the apparatus and methods described herein may be made without departing from the spirit of the inventions. The accompanying claims and there equivalents are intended to cover such forms of modifications as would fall within the scope and spirit of the invention.

What is claimed is:

1. A document processing apparatus comprising:
an electronic file storage unit that stores a plurality of electronic files;
an upload time estimation unit that if one or more electronic files stored in the electronic file storage unit are selected to be uploaded to a specific destination via a network, estimates time that will be taken to upload the selected electronic file to the destination and
a notification unit that notifies that an allowable time will be exceeded if the time estimated by the upload time estimation unit exceeds a predetermined allowable time.

2. The document processing apparatus according to claim 1, wherein the upload time estimation unit estimates a communication speed by assuming a route to the destination and estimates the time for the upload from a capacity of the specified electronic file and the estimated communication speed.

3. The document processing apparatus according to claim 2, wherein the notification by the notification unit is performed by displaying the notification on the display screen.

4. The document processing apparatus according to claim 3, wherein if a file to be uploaded is a paper document, the electronic file is obtained by scanning the paper document and stored in the electronic file storage unit.

5. The document processing apparatus according to claim 4, wherein if the upload estimation time exceeds the allowable time, the electronic file to be uploaded is modified to an electronic file having less capacity.

6. A document processing apparatus comprising:
an electronic file storage unit that stores a plurality of electronic files;
a display input unit that displays the plurality of electronic files stored in the electronic file storage unit and that makes available to select the electronic files;
a transmission speed estimation unit that if a specific electronic file to be uploaded via a network is selected from the plurality of electronic files, estimates a communication speed in a route to an upload destination if the upload destination of the selected electronic file is specified;
an upload time estimation unit that estimates an upload time from the estimated communication speed estimated by the transmission speed estimation unit and a capacity of the selected electronic file; and
a display control unit that displays an excess upload time on a display screen of the display input unit if the upload estimation time estimated by the upload time estimation unit is greater than a predetermined allowable time.

7. The document processing apparatus according to claim 6, further comprising a tab browser processing unit that can display a plurality of screens on a tab browser using a tab form,
wherein the upload is performed in one of tabs.

8. The document processing apparatus according to claim 7, wherein, if a file to be uploaded is a paper document, the electronic file is obtained by scanning the paper document, and stored in the electronic file storage unit.

9. The document processing apparatus according to claim 8, wherein if the upload estimation time exceeds the allowable time, the electronic file to be uploaded is modified to an electronic file having less capacity.

10. A method of uploading an electronic file comprising:
selecting one or more electronic files stored in an electronic file storage unit that stores a plurality of electronic files for an upload via a network;
estimating a communication speed of a route to a destination if the destination to be uploaded is specified;
estimating a time for the upload from a capacity of the selected electronic file and the estimated communication speed; and
notifying of an excess upload time if the estimated upload time exceeds an allowable upload time.
